(19) United States
(12) Patent Application Publication
(10) Pub. No.: US 2026/0118968 A1
(43) Pub. Date: Apr. 30, 2026

(54) GESTURE INTERACTION CONTROL METHOD, APPARATUS, DEVICE AND STORAGE MEDIUM

(71) Applicant: GOERTEK INC., Weifang (CN)

(72) Inventors: Yang ZHENG, Weifang (CN); Hongmei PENG, Weifang (CN)

(21) Appl. No.: 19/378,631

(22) Filed: Nov. 4, 2025

Related U.S. Application Data
(63) Continuation of application No. PCT/CN2024/136605, filed on Dec. 4, 2024.

(30) Foreign Application Priority Data
Oct. 25, 2024 (CN) 202411506677.2

(51) Int. Cl. G06F 3/01; G06T 7/73

(52) U.S. Cl. CPC G06F 3/017; G06T 7/73; G06T 2207/30196

(57) ABSTRACT

A gesture interaction control method, an apparatus, a device and a storage medium are provided The gesture interaction control method includes: obtaining pixel position information of multiple key points of an object to be identified; determining a gesture type according to the pixel position information; performing coordinate conversion on the pixel position information to obtain position information of a display device; and based on a virtual input device, controlling a behavior of the object to be identified on an interactive interface according to the gesture type and the position information of the display device.

### CROSS-REFERENCE TO RELATED APPLICATIONS

This application is a continuation application of International Application No. PCT/CN2024/136605, filed on Dec. 4, 2024, which claims priority to Chinese Patent Application No. 202411506677.2, filed with the China Patent Office on Oct. 25, 2024. All of the aforementioned applications are incorporated herein by reference in their entireties.

### TECHNICAL FIELD

The present application relates to the technical field of data processing, and in particular relates to a gesture interaction control method, an apparatus, a device, and a storage medium.

### BACKGROUND

In recent years, with the continuous development of deep learning technology, gesture recognition has become an important direction of human-computer interaction research. At present, most existing methods recognize gesture contours based on data collected by multiple sensors in the form of outlines or shapes. However, the above methods can only recognize gestures with significant differences and cannot accurately recognize gestures with subtle differences. In addition, gesture interaction is commonly controlled through an external controller, in which a corresponding operation is matched according to the identified gesture and then displayed on an interactive interface. Nevertheless, errors often occur during the behavior-matching process of the external controller. Therefore, the accuracy of gesture interaction control achieved by the above method is relatively low.

The above content is only used to assist in understanding the technical solution of the present application and does not constitute an admission that the above content is prior art.

### SUMMARY

The main purpose of the present application is to provide a gesture interaction control method, apparatus, device and storage medium, aiming to solve the technical problem of low accuracy of gesture interaction control in the related art.

To achieve the above objectives, the present application proposes a gesture interaction control method, including:
obtaining pixel position information of multiple key points of an object to be identified;
determining a gesture type according to the pixel position information;
performing coordinate conversion on the pixel position information to obtain position information of a display device; and
based on a virtual input device, controlling a behavior of the object to be identified on an interactive interface according to the gesture type and the position information of the display device.

In an embodiment, the determining the gesture type according to the pixel position information includes:
dividing the pixel position information to obtain pixel position information of multiple key points of each finger;
calculating a first Euclidean distance and a second Euclidean distance of each finger based on the pixel position information of the multiple key points of each finger based on a preset distance algorithm; and
in response to that a condition of tucking five fingers together is not satisfied according to the first Euclidean distance and the second Euclidean distance, determining the gesture type.

In an embodiment, the in response to that the condition of tucking five fingers together is not satisfied according to the first Euclidean distance and the second Euclidean distance, determining the gesture type includes:
in response to that the condition of tucking five fingers together is not satisfied according to the first Euclidean distance and the second Euclidean distance, determining whether a first Euclidean distance of a thumb is greater than a second Euclidean distance of the thumb;
in response to that the first Euclidean distance of the thumb is greater than the second Euclidean distance of the thumb, determining whether a first Euclidean distance of an index finger is less than or equal to a second Euclidean distance of the index finger, whether a first Euclidean distance of a middle finger is less than or equal to a second Euclidean distance of the middle finger, whether a first Euclidean distance of a ring finger is less than or equal to a second Euclidean distance of the ring finger, and whether a first Euclidean distance of a little finger is less than or equal to a second Euclidean distance of the little finger;
in response to that the first Euclidean distance of the index finger is less than or equal to the second Euclidean distance of the index finger, the first Euclidean distance of the middle finger is less than or equal to the second Euclidean distance of the middle finger, the first Euclidean distance of the ring finger is less than or equal to the second Euclidean distance of the ring finger, and the first Euclidean distance of the little finger is less than or equal to the second Euclidean distance of the little finger, determining relative positions of a thumb tip and a little finger tip according to characteristic values of a tucking degree of the index finger, middle finger, ring finger and little finger and a type of the object to be identified;
determining orientations of the index finger, middle finger, ring finger, and little finger according to the relative positions; and
in response to that the orientation is a preset orientation, determining the gesture type is return.

In an embodiment, the in response to that the condition of tucking five fingers together is not satisfied according to the first Euclidean distance and the second Euclidean distance, determining the gesture type includes:
in response to that the condition of tucking five fingers together is not satisfied according to the first Euclidean distance and the second Euclidean distance, determining whether a first Euclidean distance of an index finger is greater than a second Euclidean distance of the index finger;
in response to that the first Euclidean distance of the index finger is greater than the second Euclidean distance of the index finger, determining whether a first Euclidean distance of a middle finger is less than or equal to a second Euclidean distance of the middle finger, whether a first Euclidean distance of a ring finger is less than or equal to a second Euclidean distance of the ring finger, and whether a first Euclidean distance of a little finger is less than or equal to a second Euclidean distance of the little finger;
in response to that the first Euclidean distance of the middle finger is less than or equal to the second Euclidean distance of the middle finger, the first Euclidean distance of the ring finger is less than or equal to the second Euclidean distance of the ring finger, and the first Euclidean distance of the little finger is less than or equal to the second Euclidean distance of the little finger, calculating an angle between a first connecting line segment and a second connecting line segment of the index finger;
adjusting an initial angle threshold according to a joint jitter error and a detection error to obtain a target angle threshold;
in response to that the angle is less than the target angle threshold, calculating a Euclidean distance between a fingertip key point of the thumb and a fingertip key point of the index finger based on the preset distance algorithm; and in response to that the Euclidean distance between the fingertip key point of the thumb and the fingertip key point of the index finger is greater than a preset distance, determining the gesture type is cursor movement.

In an embodiment, after the adjusting the initial angle threshold according to the joint jitter error and the detection error to obtain the target angle threshold, the method further includes:
in response to that the angle is greater than or equal to the target angle threshold, determining whether the Euclidean distance between the fingertip key point of the thumb and the fingertip key point of the index finger is less than or equal to the preset distance; and
in response to that the Euclidean distance between the fingertip key point of the thumb and the fingertip key point of the index finger is less than or equal to the preset distance, determining the gesture type is click or long press.

In an embodiment, the in response to that the condition of tucking five fingers together is not satisfied according to the first Euclidean distance and the second Euclidean distance, determining the gesture type includes:
in response to determining that the condition of tucking five fingers together is not satisfied according to the first Euclidean distance and the second Euclidean distance, determining whether a first Euclidean distance of a middle finger is greater than a second Euclidean distance of the middle finger;
in response to that the first Euclidean distance of the middle finger is greater than the second Euclidean distance of the middle finger, determining whether a first Euclidean distance of a thumb is less than or equal to a second Euclidean distance of the thumb, whether a first Euclidean distance of a ring finger is less than or equal to a second Euclidean distance of the ring finger, and whether a first Euclidean distance of a little finger is less than or equal to a second Euclidean distance of the little finger;
in response to that the first Euclidean distance of the thumb is less than or equal to the second Euclidean distance of the thumb, the first Euclidean distance of the ring finger is less than or equal to the second Euclidean distance of the ring finger, and the first Euclidean distance of the little finger is less than or equal to the second Euclidean distance of the little finger, determining whether an angle between a first connecting line segment and a second connecting line segment of the index finger is greater than or equal to a target angle threshold, and whether an angle between the first connecting line segment and the second connecting line segment of the middle finger is greater than or equal to the target angle threshold; and
in response to that the angle between the first connecting line segment and the second connecting line segment of the index finger is greater than or equal to the target angle threshold, and the angle between the first connecting line segment and the second connecting line segment of the middle finger is greater than or equal to the target angle threshold, determining the gesture type is custom.

In an embodiment, the based on the virtual input device, controlling the behavior of the object to be identified on the interactive interface according to the gesture type and the position information of the display device includes:
creating the virtual input device through a target mechanism;
de-jittering the position information of the display device based on a gesture interaction management module;
sending the de-jittered position information of the display device to the virtual input device; and
based on the virtual input device, controlling the behavior of the object to be identified on the interactive interface according to the gesture type and the de-jittered position information of the display device.

In addition, in order to achieve the above objectives, the present application also provides a gesture interaction control apparatus, including:
an acquisition module, configured to obtain pixel position information of multiple key points of an object to be identified;
a determination module, configured to determine a gesture type according to the pixel position information;
a conversion module, configured to perform coordinate conversion on the pixel position information to obtain position information of a display device; and
a control module, configured to control, based on a virtual input device, a behavior of the object to be identified on an interactive interface according to the gesture type and the position information of the display device.

In addition, in order to achieve the above objectives, the present application also provides a gesture interaction control device, including:
a memory;
a processor; and
a computer program stored in the memory and executable on the processor,
the computer program is configured to implement of the gesture interaction control method as described above.

In addition, in order to achieve the above objectives, the present application also provides a non-transitory computer-readable storage medium, storing a computer program, when the computer program is executed by a processor, the gesture interaction control method according to claim 1 is implemented.

One or more technical solutions proposed in the present application have at least the following technical effects: by obtaining pixel position information of multiple key points of an object to be identified; determining a gesture type according to the pixel position information; performing coordinate conversion on the pixel position information to obtain position information of a display device; and based on a virtual input device, controlling a behavior of the object to be identified on an interactive interface according to the gesture type and the position information of the display device. Through the above method, on the basis of an open source recognition algorithm, the extension and bending of each finger is determined based on the pixel position information of multiple key points of the object to be identified, and the gesture type is further determined, and a coordinate conversion is performed on the pixel position information according to the requirements of the interactive application, and then the behavior on the interactive interface is controlled based on the virtual input device, thereby effectively improving the accuracy of controlling gesture interaction, allowing gesture behavior to be better displayed on the interactive interface, and enhancing the user experience.

### BRIEF DESCRIPTION OF THE DRAWINGS

The accompanying drawings, which are incorporated in and constitute a part of this specification, illustrate embodiments consistent with the present application and, together with the description, serve to explain the principles of the present application.

In order to more clearly illustrate the embodiments of the present application or the technical solutions in the related art, the following briefly introduces the drawings required for use in the embodiments or the description of the related art. Obviously, for those skilled in the art, other drawings can be obtained based on these drawings without any creative work.

FIG. 1 is a flow chart of a gesture interaction control method according to a first embodiment of the present application.

FIG. 2 is a schematic diagram of positions of key points of the gesture interaction control method according to the first embodiment of the present application.

FIG. 3 is a flow chart of the gesture interaction control method according to a second embodiment of the present application.

FIG. 4 is a schematic diagram of gesture types of the gesture interaction control method according to the second embodiment of the present application.

FIG. 5 is a structural schematic diagram of a gesture interaction control apparatus according to an embodiment of the present application.

FIG. 6 is a structural schematic diagram of a hardware operating environment involved in the gesture interaction control method according to an embodiment of the present application.

The purpose, features and advantages of the present application will be further explained in conjunction with the embodiments and with reference to the accompanying drawings.

### DETAILED DESCRIPTION OF THE EMBODIMENTS

It should be noted that the execution subject of this embodiment can be a computing service device with data processing, network communication, and program execution functions, such as a tablet computer, personal computer, mobile phone, etc., or an electronic device capable of implementing the above functions, a gesture interaction control device, etc. The following uses a gesture interaction control device as an example to illustrate this embodiment and the following embodiments.

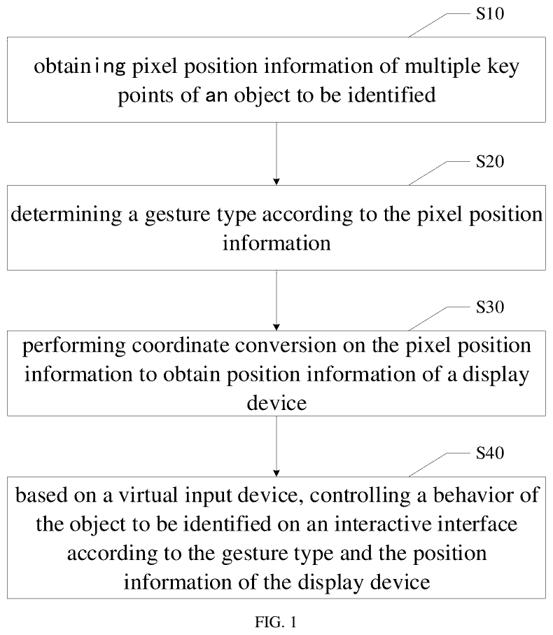

Based on this, an embodiment of the present application provides a gesture interaction control method. As shown in FIG. 1, which is a flow chart of the gesture interaction control method according to a first embodiment of the present application.

In the embodiment, the gesture interaction control method includes steps S10 to S40.

Step S10, obtaining pixel position information of multiple key points of an object to be identified.

It should be noted that the object to be identified refers to the object that controls the behavior on the interactive interface. The object to be identified can be a gesture that needs to be identified. The quantity of key points of the object to be identified can be 21, and these key points can be identified using an open source algorithm, such as Pytorch. The position information of the key points in this case can be represented by the pixel coordinates of the image.

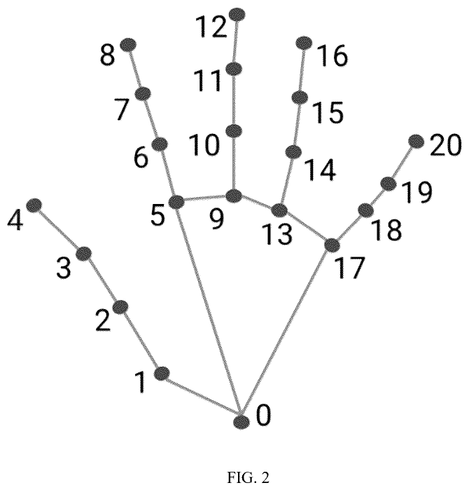

It should be understood that, as shown in FIG. 2, FIG. 2 is a schematic diagr am of positions of the key points. In an embodiment, 21 key points can be marked by solid dots with the serial number, 0-20, respectively, where 0 represents wrist WRIST, 1 represents THUMB_CMC, 2 represents THUMB_MCP, 3 represents THUMB_IP, 4 repres ents THUMB_TIP, 5 represents INDEX_FINGER_MCP, 6 represents INDEX_FINGER_PI P, 7 represents INDEX_FINGER_DIP, 8 represents INDEX_FINGER_TIP, 9 represents MI DDLE FINGER_MCP, 10 represents MIDDLE_FINGER_PIP, 11 represents MIDDLE_FI NGER_DIP, 12 represents MIDDLE_FINGER_TIP, 13 represents RING_FINGER_MCP, 14 represents RING_FINGER_PIP, 15 represents RING_FINGER_DIP, 16 represents RING FINGER_TIP, 17 represents PINKY_MCP, 18 represents PINKY_PIP, 19 represents PIN KY_DIP, and 20 represents PINKY_TIP.

Step S20, determining a gesture type according to the pixel position information.

It is understandable that the gesture type refers to the type of identified gesture, which includes but is not limited to return, cursor movement, click, long press, and custom.

Step S30, performing coordinate conversion on the pixel position information to obtain position information of the display device.

It should be understood that for interactive application requirements, it is necessary to determine the position of the hand on the display device, which can be a screen. In this case, it is necessary to convert the pixel position information into position information of the display device by coordinate conversion based on the mapping relationship between the display device and the image. For example, if the image size is w₁*h₁, the image coordinate of the key point are (x₁,y₁), the resolution of the display device is w₂*h₂, and the display device coordinates of the key point are (x₂, y₂), then the mapping conversion formula is:

$$\{ \begin{matrix}{x}_{2} = {x}_{1} * \frac{{w}_{2}}{{w}_{1}} \\ {y}_{2} = {y}_{1} * \frac{{h}_{2}}{{h}_{1}}\end{matrix}$$

Step S40, based on a virtual input device, controlling a behavior of the object to be identified on an interactive interface according to the gesture type and the position information of the display device.

It can be understood that a virtual input device refers to an input device virtually created using a target mechanism. The virtual input device can be a touch screen, touchpad, etc., to support actions such as clicking, moving, long pressing, and dragging. For a virtual input device, the gesture type and position information of the display device will be reported, which will be manifested on the interactive interface as clicking, moving, etc. on the virtual input device, for example, moving the cursor.

Furthermore, step S40 includes: creating the virtual input device through a target mechanism; de-jittering the position information of the display device based on a gesture interaction management module; sending the de-jittered position information of the display device to the virtual input device; and based on the virtual input device, controlling the behavior of the object to be identified on the interactive interface according to the gesture type and the de-jittered position information of the display device.

It should be understood that the target mechanism refers to the mechanism used to virtually create an input device. The target mechanism can be the Uinput mechanism. After identifying the gesture type, the data will be updated in real time and then sent to the gesture interaction management module. For the gesture interaction management module, the above data will be de-jittered to eliminate tiny jitters, and then the de-jittered position information of the display device will be sent to the virtual input device, and the behavior of the object to be identified on the interactive interface will be controlled based on the virtual input device.

The embodiment of the present application includes: obtaining pixel position information of multiple key points of an object to be identified; determining a gesture type according to the pixel position information; performing coordinate conversion on the pixel position information to obtain position information of a display device; and based on a virtual input device, controlling a behavior of the object to be identified on an interactive interface according to the gesture type and the position information of the display device. Through the above method, on the basis of an open source recognition algorithm, the extension and bending of each finger is determined based on the pixel position information of multiple key points of the object to be identified, and the gesture type is further determined, and a coordinate conversion is performed on the pixel position information according to the requirements of the interactive application, and then the behavior on the interactive interface is controlled based on the virtual input device, thereby effectively improving the accuracy of controlling gesture interaction, allowing gesture behavior to be better displayed on the interactive interface, and enhancing the user experience.

Based on the first embodiment of the present application, in the second embodiment of the present application, the same or similar contents as those in the above-mentioned first embodiment can be referred to the above introduction and will not be repeated hereafter. On this basis, as shown in FIG. 3, step S20 includes steps S201 to S203.

Step S201, dividing the pixel position information to obtain pixel position information of multiple key points of each finger.

It should be noted that, since the object to be identified represents the entire gesture, and the entire gesture is composed of multiple fingers, the pixel position information can be divided into pixel position information of multiple key points of each finger according to the finger type. For example, pixel position information of multiple key points of the thumb (key points numbered 0, 1, 2, 3 and 4), pixel position information of multiple key points of the index finger (key points numbered 0, 5, 6, 7 and 8), pixel position information of multiple key points of the middle finger (key points numbered 0, 9, 10, 11 and 12), pixel position information of multiple key points of the ring finger (key points numbered 0, 13, 14, 15 and 16), and pixel position information of multiple key points of the little finger (key points numbered 0, 17, 18, 19 and 20).

Step S202, calculating a first Euclidean distance and a second Euclidean distance of each finger based on the pixel position information of the multiple key points of each finger based on a preset distance algorithm.

It can be understood that the preset distance algorithm refers to an algorithm for calculating the Euclidean distance between two key points. For example, the pixel coordinates corresponding to the pixel position information of the i-th key point among multiple key points are defined as (pᵢ(x), pᵢ(y)), and i=0, 1, 2 . . . 20 the Euclidean distance between the two key points is: i,j

$${dist}_{i , j} = \sqrt{{( {p}_{1} ( x ) - {p}_{j} ( x ) )}^{2} + {( {p}_{1} ( y ) - {p}_{j} ( y ) )}^{2}}$$

It should be understood that after obtaining the pixel position information of multiple key points of each finger, the above-mentioned distance algorithm is configured to calculate the first Euclidean distance and the second Euclidean distance of each finger respectively. For the thumb, the first Euclidean distance represents the Euclidean distance between the key points numbered 0 and 4, that is dist_{0,4}. The second Euclidean distance represents the Euclidean distance between the key points numbered 0 and 2, that is dist_{0,2}. For the index finger, the first Euclidean distance represents the Euclidean distance between the key points numbered 0 and 8, that is dist_{0,8}. The second Euclidean distance represents the Euclidean distance between the key points numbered 0 and 6, that is dist_{0,6}. For the middle finger, the first Euclidean distance represents the Euclidean distance between the key points numbered 0 and 12, that is dist_{0,12}, the second Euclidean distance represents the Euclidean distance between the key points numbered 0 and 10, that is dist_{0,10}. For the ring finger, the first Euclidean distance represents the Euclidean distance between the key points numbered 0 and 16, that is dist_{0,16}, the second Euclidean distance represents the Euclidean distance between the key points numbered 0 and 14, that is dist_{0,14}. For the little finger, the first Euclidean distance represents the Euclidean distance between the key points numbered 0 and 20, that is dist_{0,20}. The second Euclidean distance represents the Euclidean distance between the key points numbered 0 and 18, that is dist_{0,18}.

Step S203, in response to that a condition of tucking five fingers together is not satisfied according to the first Euclidean distance and the second Euclidean distance, determining the gesture type.

It should be understood that after obtaining the first Euclidean distance and the second Euclidean distance of each finger, the comparison result of the first Euclidean distance and the second Euclidean distance is used to determine whether the condition of tucking five fingers together is met. In an embodiment, determining whether the first Euclidean distance of the thumb is greater than the second Euclidean distance of the thumb, that is, whether dist_{0,4}, is greater than dist_{0,2}; determining whether the first Euclidean distance of the index finger is greater than the second Euclidean distance of the index finger, that is, whether dist_{0,8} is greater than dist_{0,6}; determining whether the first Euclidean distance of the middle finger is greater than the second Euclidean distance of the middle finger, that is, whether dist_{0,12} is greater than dist0,10; determining whether the first Euclidean distance of the ring finger is greater than the second Euclidean distance of the ring finger, that is, whether dist_{0,16} is greater than dist_{0,14}; and determining whether the first Euclidean distance of the little finger is greater than the second Euclidean distance of the little finger, that is, whether dist_{0,20} is greater than dist_{0,18}. If any of the above conditions is met, it indicates that the condition of tucking five fingers together is not met, and the gesture type is further determined at this time.

In an embodiment, step S203 includes: in response to that the condition of tucking five fingers together is not satisfied according to the first Euclidean distance and the second Euclidean distance, determining whether a first Euclidean distance of a thumb is greater than a second Euclidean distance of the thumb;
in response to that the first Euclidean distance of the thumb is greater than the second Euclidean distance of the thumb, determining whether a first Euclidean distance of an index finger is less than or equal to a second Euclidean distance of the index finger, whether a first Euclidean distance of a middle finger is less than or equal to a second Euclidean distance of the middle finger, whether a first Euclidean distance of a ring finger is less than or equal to a second Euclidean distance of the ring finger, and whether a first Euclidean distance of a little finger is less than or equal to a second Euclidean distance of the little finger;
in response to that the first Euclidean distance of the index finger is less than or equal to the second Euclidean distance of the index finger, the first Euclidean distance of the middle finger is less than or equal to the second Euclidean distance of the middle finger, the first Euclidean distance of the ring finger is less than or equal to the second Euclidean distance of the ring finger, and the first Euclidean distance of the little finger is less than or equal to the second Euclidean distance of the little finger, determining relative positions of a thumb tip and a little finger tip according to characteristic values of a tucking degree of the index finger, middle finger, ring finger and little finger and a type of the object to be identified;
determining orientations of the index finger, middle finger, ring finger, and little finger according to the relative positions; and
in response to that the orientation is a preset orientation, determining the gesture type is return.

It can be understood that, when it is determined according to the first Euclidean distance and the second Euclidean distance that the condition of tucking five fingers together is not satisfied, the first Euclidean distance of the thumb is greater than the second Euclidean distance of the thumb, the first Euclidean distance of the index finger is less than or equal to the second Euclidean distance of the index finger, the first Euclidean distance of the middle finger is less than or equal to the second Euclidean distance of the middle finger, the first Euclidean distance of the ring finger is less than or equal to the second Euclidean distance of the ring finger, and the first Euclidean distance of the little finger is less than or equal to the second Euclidean distance of the little finger, it indicates that the thumb is extended, the index finger, the middle finger, the ring finger and the little finger are tucked. At this time, it is necessary to further determine whether the index finger, middle finger, ring finger and little finger are facing oneself. In an embodiment, when the type of the object to be identified is the left hand and the characteristic value of the tucking degree of the index finger, middle finger, ring finger and little finger is greater than the preset threshold, the relative position is determined to be that the fingertip of the thumb is on the upper left side of the fingertip of the little finger. When the type of the object to be identified is the right hand and the characteristic value of the tucking degree of the index finger, middle finger, ring finger and little finger is greater than the preset threshold, the relative position is determined to be that the fingertip of the thumb is on the upper right side of the fingertip of the little finger. The specific formula is:

$$\{ \begin{matrix}{p}_{4} ( x ) < {p}_{20} ( x ) , {p}_{4} ( y ) < {p}_{20} ( y ) , left\_hand \\ {p}_{4} ( x ) > {p}_{20} ( x ) , {p}_{4} ( y ) < {p}_{20} ( y ) , right\_hand\end{matrix}$$

When the above conditions are met, it indicates that the orientation is the preset orientation, and the gesture type is determined to be return.

In an embodiment, step S203 includes: in response to that the condition of tucking five fingers together is not satisfied according to the first Euclidean distance and the second Euclidean distance, determining whether a first Euclidean distance of an index finger is greater than a second Euclidean distance of the index finger;
in response to that the first Euclidean distance of the index finger is greater than the second Euclidean distance of the index finger, determining whether a first Euclidean distance of a middle finger is less than or equal to a second Euclidean distance of the middle finger, whether a first Euclidean distance of a ring finger is less than or equal to a second Euclidean distance of the ring finger, and whether a first Euclidean distance of a little finger is less than or equal to a second Euclidean distance of the little finger;
in response to that the first Euclidean distance of the middle finger is less than or equal to the second Euclidean distance of the middle finger, the first Euclidean distance of the ring finger is less than or equal to the second Euclidean distance of the ring finger, and the first Euclidean distance of the little finger is less than or equal to the second Euclidean distance of the little finger, calculating an angle between a first connecting line segment and a second connecting line segment of the index finger;
adjusting an initial angle threshold according to a joint jitter error and a detection error to obtain a target angle threshold;
in response to that the angle is less than the target angle threshold, calculating a Euclidean distance between a fingertip key point of the thumb and a fingertip key point of the index finger based on the preset distance algorithm; and
in response to that the Euclidean distance between the fingertip key point of the thumb and the fingertip key point of the index finger is greater than a preset distance, determining the gesture type is cursor movement.

It should be understood that when it is determined according to the first Euclidean distance and the second Euclidean distance that the condition of tucking five fingers together is not met, the first Euclidean distance of the index finger is greater than the second Euclidean distance of the index finger, the first Euclidean distance of the middle finger is less than or equal to the second Euclidean distance of the middle finger, the first Euclidean distance of the ring finger is less than or equal to the second Euclidean distance of the ring finger, and the first Euclidean distance of the little finger is less than or equal to the second Euclidean distance of the little finger, it indicates that the index finger is extended, and the middle finger, ring finger and little finger are tucked. At this time, it is necessary to further determine whether the index finger is bent and whether the thumb and index finger are pinched. In an embodiment, whether the angle between the first connecting line segment and the second connecting line segment of the index finger is less than the target angle threshold, and whether the Euclidean distance between the fingertip key point of the thumb and the fingertip key point of the index finger is greater than the preset distance is determined. The first connecting line segment of the index finger is the line segment connecting the key points numbered 6 and 5, and the second connecting line segment is the line segment connecting the key points numbered 6 and 8. Taking into account the jitter of the finger joint itself and the deviation of the actual detection, it is necessary to adjust the initial angle threshold according to the joint jitter error and the detection error. For example, the initial angle threshold is 180°, then the adjusted target angle threshold is 180°−T₁, and T₁∈[5°,10°]. The specific formula for calculating the angle between the first connecting line segment and the second connecting line segment of the index finger is:

$${θ}_{sz} = \frac{arccos ( {dist}_{6 , 5}^{2} + {dist}_{6 , 8}^{2} - {dist}_{5 , 8}^{2} )}{2 * {dist}_{6 , 5} * {dist}_{6 , 8}}$$

It should be noted that after calculating the angle between the first connecting line segment and the second connecting line segment of the index finger, it is necessary to determine whether the angle is less than the target angle threshold. If so, it indicates that the index finger is bent. At this time, it is further determined whether the Euclidean distance between the fingertip key point of the thumb and the fingertip key point of the index finger is greater than the preset distance. The fingertip key point of the thumb can be the key point numbered 4, and the fingertip key point of the index finger can be the key point numbered 8. The preset distance can be positioned as 5 pixels. If the above conditions are met, it indicates that the thumb and index finger are not pinched together, and it is determined to be cursor movement.

Furthermore, after the adjusting the initial angle threshold according to the joint jitter error and the detection error to obtain the target angle threshold, the method also includes: in response to that the angle is greater than or equal to the target angle threshold, determining whether the Euclidean distance between the fingertip key point of the thumb and the fingertip key point of the index finger is less than or equal to the preset distance; in response to that the Euclidean distance between the fingertip key point of the thumb and the fingertip key point of the index finger is less than or equal to the preset distance, determining the gesture type is click or a long press.

It can be understood that when it is determined that the angle between the first connecting line segment and the second connecting line segment of the index finger is greater than or equal to the target angle threshold, it indicates that the index finger is not bent. At this time, it is further determined whether the Euclidean distance between the fingertip key point of the thumb and the fingertip key point of the index finger is less than or equal to the preset distance. If the Euclidean distance between the fingertip key point of the thumb and the fingertip key point of the index finger is less than or equal to the preset distance, it indicates that the thumb and index finger are pinched together, and the gesture type is determined as click or long press.

In an embodiment, step S203 includes: in response to determining that the condition of tucking five fingers together is not satisfied according to the first Euclidean distance and the second Euclidean distance, determining whether a first Euclidean distance of a middle finger is greater than a second Euclidean distance of the middle finger;
in response to that the first Euclidean distance of the middle finger is greater than the second Euclidean distance of the middle finger, determining whether a first Euclidean distance of a thumb is less than or equal to a second Euclidean distance of the thumb, whether a first Euclidean distance of a ring finger is less than or equal to a second Euclidean distance of the ring finger, and whether a first Euclidean distance of a little finger is less than or equal to a second Euclidean distance of the little finger;
in response to that the first Euclidean distance of the thumb is less than or equal to the second Euclidean distance of the thumb, the first Euclidean distance of the ring finger is less than or equal to the second Euclidean distance of the ring finger, and the first Euclidean distance of the little finger is less than or equal to the second Euclidean distance of the little finger, determining whether an angle between a first connecting line segment and a second connecting line segment of the index finger is greater than or equal to a target angle threshold, and whether an angle between the first connecting line segment and the second connecting line segment of the middle finger is greater than or equal to the target angle threshold; and
in response to that the angle between the first connecting line segment and the second connecting line segment of the index finger is greater than or equal to the target angle threshold, and the angle between the first connecting line segment and the second connecting line segment of the middle finger is greater than or equal to the target angle threshold, determining the gesture type is custom.

It should be understood that when it is determined according to the first Euclidean distance and the second Euclidean distance that the condition of tucking five fingers together is not met, the first Euclidean distance of the middle finger is greater than the second Euclidean distance of the middle finger, the first Euclidean distance of the thumb is less than or equal to the second Euclidean distance of the thumb, the first Euclidean distance of the ring finger is less than or equal to the second Euclidean distance of the ring finger, and the first Euclidean distance of the little finger is less than or equal to the second Euclidean distance of the little finger, it indicates that the middle finger is extended and the thumb, ring finger and little finger are tucked. At this time, it is further determined whether the middle finger and index finger are straightened. In an embodiment, whether the angle between the first connecting line segment and the second connecting line segment of the index finger is greater than or equal to the target angle threshold, and whether the angle between the first connecting line segment and the second connecting line segment of the middle finger is greater than or equal to the target angle threshold is determined. The first connecting line segment of the middle finger is a line segment connecting the key points numbered 10 and 9, and the second connecting line segment is a line segment connecting the key points numbered 10 and 13. The specific formula for calculating the angle between the first connecting line segment and the second connecting line segment of the middle finger is:

$${θ}_{zz} = \frac{arccos ( {dist}_{10 , 9}^{2} + {dist}_{10 , 12}^{2} - {dist}_{9 , 12}^{2} )}{2 * {dist}_{10 , 9} * {dist}_{10 , 12}}$$

It should be noted that when it is determined that the angle between the first connecting line segment and the second connecting line segment of the index finger is greater than or equal to the target angle threshold, and the angle between the first connecting line segment and the second connecting line segment of the middle finger is greater than or equal to the target angle threshold, it indicates that both the middle finger and the index finger are straightened, and the gesture type is determined to be custom.

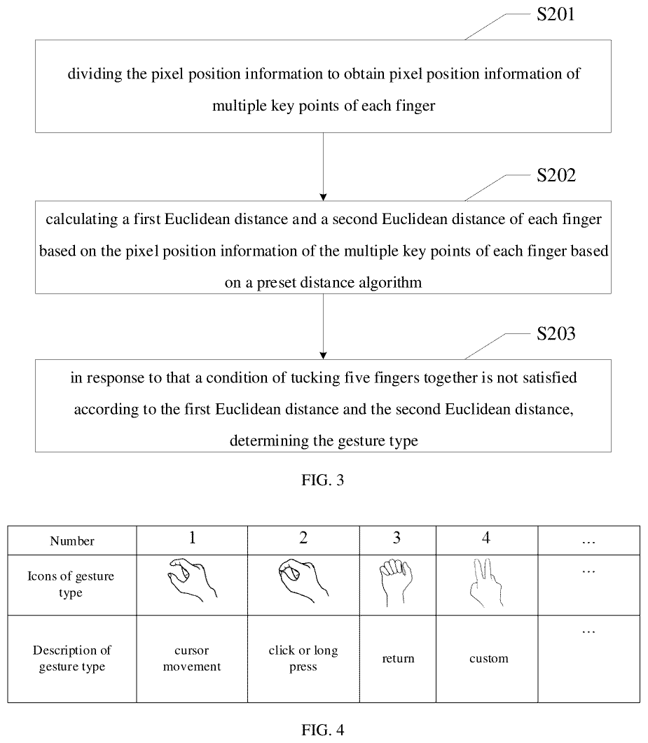

As shown in FIG. 4, which is a schematic diagram of gesture types. In an embodiment, four gesture types are used as examples for explanation. The first gesture type is cursor movement, the second gesture type is click or long press, the third gesture type is return, and the fourth is custom.

The embodiment of the present application includes: dividing the pixel position information to obtain pixel position information of multiple key points of each finger; calculating a first Euclidean distance and a second Euclidean distance of each finger based on the pixel position information of the multiple key points of each finger based on a preset distance algorithm; and in response to that a condition of tucking five fingers together is not satisfied according to the first Euclidean distance and the second Euclidean distance, determining the gesture type. Through the above method, after the pixel position information of multiple key points of the object to be identified is divided into the pixel position information of multiple key points of each finger, the first Euclidean distance and the second Euclidean distance of each finger are calculated according to the pixel coordinates using the preset distance algorithm, and whether five fingers are tucked together is determined based on the comparison result of the first Euclidean distance and the second Euclidean distance. If not, it indicates that the condition of tucking five fingers together is not met. At this time, the gesture type is further determined from dimensions such as the direction of the fingers, the tucking of the thumb and index finger, the bending of the index finger, and the straightening of the middle finger and index finger, thereby effectively improving the accuracy of determining the gesture type.

The present application also provides a gesture interaction control apparatus, as shown in FIG. 5, the gesture interaction control apparatus includes: an acquisition module 10, a determination module 20, a conversion module 30 and a control module 40.

The acquisition module 10 is configured to obtain pixel position information of multiple key points of an object to be identified.

The determination module 20 is configured to determine a gesture type according to the pixel position information.

The conversion module 30 is configured to perform coordinate conversion on the pixel position information to obtain position information of a display device.

The control module 40 is configured to control, based on a virtual input device, a behavior of the object to be identified on an interactive interface according to the gesture type and the position information of the display device.

The embodiment of the present application includes: obtaining pixel position information of multiple key points of an object to be identified; determining a gesture type according to the pixel position information; performing coordinate conversion on the pixel position information to obtain position information of a display device; and based on a virtual input device, controlling a behavior of the object to be identified on an interactive interface according to the gesture type and the position information of the display device. Through the above method, on the basis of an open source recognition algorithm, the extension and bending of each finger is determined based on the pixel position information of multiple key points of the object to be identified, and the gesture type is further determined, and a coordinate conversion is performed on the pixel position information according to the requirements of the interactive application, and then the behavior on the interactive interface is controlled based on the virtual input device, thereby effectively improving the accuracy of controlling gesture interaction, allowing gesture behavior to be better displayed on the interactive interface, and enhancing the user experience.

In an embodiment, the determination module 20 is further configured to divide the pixel position information to obtain pixel position information of multiple key points of each finger; calculate a first Euclidean distance and a second Euclidean distance of each finger based on the pixel position information of the multiple key points of each finger based on a preset distance algorithm; and in response to that a condition of tucking five fingers together is not satisfied according to the first Euclidean distance and the second Euclidean distance, determine the gesture type.

In an embodiment, the determination module 20 is further configured to in response to that the condition of tucking five fingers together is not satisfied according to the first Euclidean distance and the second Euclidean distance, determine whether a first Euclidean distance of a thumb is greater than a second Euclidean distance of the thumb; in response to that the first Euclidean distance of the thumb is greater than the second Euclidean distance of the thumb, determine whether a first Euclidean distance of an index finger is less than or equal to a second Euclidean distance of the index finger, whether a first Euclidean distance of a middle finger is less than or equal to a second Euclidean distance of the middle finger, whether a first Euclidean distance of a ring finger is less than or equal to a second Euclidean distance of the ring finger, and whether a first Euclidean distance of a little finger is less than or equal to a second Euclidean distance of the little finger; in response to that the first Euclidean distance of the index finger is less than or equal to the second Euclidean distance of the index finger, the first Euclidean distance of the middle finger is less than or equal to the second Euclidean distance of the middle finger, the first Euclidean distance of the ring finger is less than or equal to the second Euclidean distance of the ring finger, and the first Euclidean distance of the little finger is less than or equal to the second Euclidean distance of the little finger, determine relative positions of a thumb tip and a little finger tip according to characteristic values of a tucking degree of the index finger, middle finger, ring finger and little finger and a type of the object to be identified; determine orientations of the index finger, middle finger, ring finger, and little finger according to the relative positions; and in response to that the orientation is a preset orientation, determine the gesture type is return.

In an embodiment, the determination module 20 is further configured to in response to that the condition of tucking five fingers together is not satisfied according to the first Euclidean distance and the second Euclidean distance, determine whether a first Euclidean distance of an index finger is greater than a second Euclidean distance of the index finger; in response to that the first Euclidean distance of the index finger is greater than the second Euclidean distance of the index finger, determine whether a first Euclidean distance of a middle finger is less than or equal to a second Euclidean distance of the middle finger, whether a first Euclidean distance of a ring finger is less than or equal to a second Euclidean distance of the ring finger, and whether a first Euclidean distance of a little finger is less than or equal to a second Euclidean distance of the little finger; in response to that the first Euclidean distance of the middle finger is less than or equal to the second Euclidean distance of the middle finger, the first Euclidean distance of the ring finger is less than or equal to the second Euclidean distance of the ring finger, and the first Euclidean distance of the little finger is less than or equal to the second Euclidean distance of the little finger, calculate an angle between a first connecting line segment and a second connecting line segment of the index finger; adjust an initial angle threshold according to a joint jitter error and a detection error to obtain a target angle threshold; in response to that the angle is less than the target angle threshold, calculate a Euclidean distance between a fingertip key point of the thumb and a fingertip key point of the index finger based on the preset distance algorithm; and in response to that the Euclidean distance between the fingertip key point of the thumb and the fingertip key point of the index finger is greater than a preset distance, determine the gesture type is cursor movement.

In an embodiment, the determination module 20 is further configured to in response to that the angle is greater than or equal to the target angle threshold, determine whether the Euclidean distance between the fingertip key point of the thumb and the fingertip key point of the index finger is less than or equal to the preset distance; in response to that the Euclidean distance between the fingertip key point of the thumb and the fingertip key point of the index finger is less than or equal to the preset distance, determine the gesture type is click or a long press.

In an embodiment, the determination module 20 is further configured to in response to determining that the condition of tucking five fingers together is not satisfied according to the first Euclidean distance and the second Euclidean distance, determine whether a first Euclidean distance of a middle finger is greater than a second Euclidean distance of the middle finger; in response to that the first Euclidean distance of the middle finger is greater than the second Euclidean distance of the middle finger, determine whether a first Euclidean distance of a thumb is less than or equal to a second Euclidean distance of the thumb, whether a first Euclidean distance of a ring finger is less than or equal to a second Euclidean distance of the ring finger, and whether a first Euclidean distance of a little finger is less than or equal to a second Euclidean distance of the little finger; in response to that the first Euclidean distance of the thumb is less than or equal to the second Euclidean distance of the thumb, the first Euclidean distance of the ring finger is less than or equal to the second Euclidean distance of the ring finger, and the first Euclidean distance of the little finger is less than or equal to the second Euclidean distance of the little finger, determine whether an angle between a first connecting line segment and a second connecting line segment of the index finger is greater than or equal to a target angle threshold, and whether an angle between the first connecting line segment and the second connecting line segment of the middle finger is greater than or equal to the target angle threshold; and in response to that the angle between the first connecting line segment and the second connecting line segment of the index finger is greater than or equal to the target angle threshold, and the angle between the first connecting line segment and the second connecting line segment of the middle finger is greater than or equal to the target angle threshold, determine the gesture type is custom.

In an embodiment, the control module 40 is further configured to create the virtual input device through a target mechanism; de-jitter the position information of the display device based on a gesture interaction management module; send the de-jittered position information of the display device to the virtual input device; and based on the virtual input device, control the behavior of the object to be identified on the interactive interface according to the gesture type and the de-jittered position information of the display device.

The gesture interaction control apparatus provided in the present application utilizes the gesture interaction control method described in the aforementioned embodiments, addressing the technical problem of low accuracy in gesture interaction control in the related art. Compared to the related art, the beneficial effects of the gesture interaction control apparatus provided in the present application are the same as those of the gesture interaction control method described in the aforementioned embodiments. Other technical features of the gesture interaction control apparatus are the same as those disclosed in the aforementioned embodiments and are not further elaborated here.

The present application provides a gesture interaction control device, which includes: at least one processor; and a memory communicatively connected to the at least one processor; the memory stores instructions executable by the at least one processor, and the instructions are executed by the at least one processor to enable the at least one processor to perform the gesture interaction control method in the above-mentioned first embodiment.

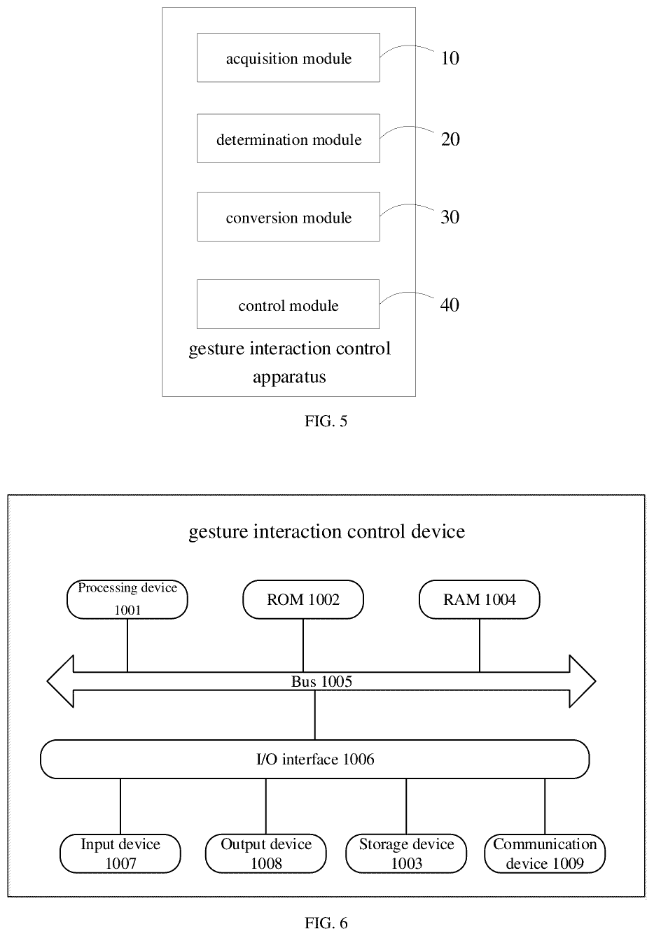

As shown in FIG. 6, which illustrates a structural schematic diagram of a gesture interaction control device suitable for implementing embodiments of the present application. The gesture interaction control device in embodiments of the present application may include, but is not limited to, mobile terminals such as mobile phones, laptop computers, digital broadcast receivers, Personal Digital Assistants (PDAs), Portable Application Descriptions (PADs), Portable Media Players (PMPs), in-vehicle terminals (e.g., in-vehicle navigation terminals), and fixed terminals such as digital TVs and desktop computers. The gesture interaction control device shown in FIG. 6 is merely an example and should not limit the functionality or scope of use of the embodiments of the present application.

As shown in FIG. 6, the gesture interaction control device may include a processing device 1001 (e.g., a central processing unit, graphics processing unit, etc.), which can perform various appropriate actions and processes based on programs stored in a read-only memory (ROM) 1002 or programs loaded from a storage device 1003 into a random access memory (RAM) 1004. RAM 1004 also stores various programs and data required for the operation of the gesture interaction control device. Processing device 1001, ROM 1002, and RAM 1004 are interconnected via a bus 1005. An input/output (I/O) interface 1006 is also connected to the bus. Typically, the following systems can be connected to I/O interface 1006: input devices 1007, such as a touchscreen, touchpad, keyboard, mouse, image sensor, microphone, accelerometer, gyroscope, etc.; output devices 1008, such as a liquid crystal display (LCD), speaker, vibrator, etc.; storage device 1003, such as a magnetic tape or hard disk; and communication device 1009. The communication device 1009 can allow the gesture interaction control device to communicate with other devices wirelessly or wired to exchange data. Although the figure shows a gesture interaction control device with various systems, it should be understood that it is not required to implement or have all of the systems shown. More or fewer systems may be implemented or have alternatively.

In particular, according to the embodiments disclosed herein, the processes described above with reference to the flowcharts can be implemented as computer software programs. The computer programs contain program code for executing the methods shown in the flowcharts. In such embodiments, the computer programs can be downloaded and installed from a network via a communication device, or installed from storage device 1003, or installed from ROM 1002. When the computer programs are executed by processing device 1001, the above-described functions defined in the methods of the embodiments disclosed herein are performed.

The gesture interaction control device provided in the present application utilizes the gesture interaction control method described in the aforementioned embodiment, addressing the technical issue of low accuracy in gesture interaction control in the related art. Compared to the related art, the beneficial effects of the gesture interaction control device provided in the present application are the same as those of the gesture interaction control method described in the aforementioned embodiment. Other technical features of the gesture interaction control device are the same as those disclosed in the aforementioned embodiment and are not further elaborated here.

It should be understood that the various parts disclosed in the present application can be implemented using hardware, software, firmware, or a combination thereof. In the description of the above embodiments, specific features, structures, materials, or characteristics can be combined in any one or more embodiments or examples in a suitable manner.

The above description is merely a specific embodiment of the present application, but the scope of protection of the present application is not limited thereto. Any changes or substitutions that can be easily conceived by a person skilled in the art within the technical scope disclosed in the present application should be included in the scope of protection of the present application. Therefore, the scope of protection of the present application should be based on the scope of protection of the claims.

The present application provides a computer-readable storage medium having computer-readable program instructions (i.e., computer program) stored thereon, the computer-readable program instructions are used to execute the gesture interaction control method in the above-mentioned embodiment.

herein may be, for example, a USB flash drive, but is not limited to electrical, magnetic, optical, electromagnetic, infrared, or semiconductor systems, systems, or devices, or any combination thereof. More specific examples of computer-readable storage media may include, but are not limited to, an electrical connection having one or more wires, a portable computer disk, a hard disk, a RAM, a ROM, an erasable programmable read-only memory (EPROM or flash memory), optical fiber, a portable compact disk read-only memory (CD-ROM), an optical storage device, a magnetic storage device, or any suitable combination thereof. In the embodiment, the computer-readable storage medium may be any tangible medium that contains or stores a program that can be used by or in conjunction with an instruction execution system, system, or device. The program code contained on the computer-readable storage medium may be transmitted using any suitable medium, including, but not limited to, wires, optical cables, Radio Frequency (RF), etc., or any suitable combination thereof.

The computer-readable storage medium may be included in the gesture interaction control device, or may exist independently without being incorporated into the gesture interaction control device.

The present application may be written in one or more programming languages, or a combination thereof, including object-oriented programming languages such as Java, Smalltalk, C++, and conventional procedural programming languages such as “C” or similar programming languages. The program code may be executed entirely on the user's computer, partially on the user's computer, as a stand-alone software package, partially on the user's computer and partially on a remote computer, or entirely on a remote computer or server. In the case of a remote computer, the remote computer may be connected to the user's computer via any type of network, including a local area network (LAN) or a wide area network (WAN), or may be connected to an external computer (e.g., via the Internet using an Internet service provider).

The flow charts and block diagrams in the accompanying drawings illustrate the possible implementation architecture, functions and operations of the systems and methods according to various embodiments of the present application. In this regard, each box in the flow chart or block diagram can represent a module, program segment, or a part of code, and the module, program segment, or a part of code contains one or more executable instructions for realizing the specified logical function. It should also be noted that in some alternative implementations, the functions marked in the box can also occur in a different order than that marked in the accompanying drawings. For example, two boxes represented in succession can actually be executed substantially in parallel, and they can sometimes be executed in the opposite order, depending on the functions involved. It should also be noted that each box in the block diagram and/or flow chart, and the combination of the boxes in the block diagram and/or flow chart can be implemented by a dedicated hardware-based system that performs the specified function or operation, or can be implemented by a combination of dedicated hardware and computer instructions.

The modules described in the embodiments of the present application may be implemented in software or hardware, the name of a module does not necessarily limit the unit itself.

The computer-readable storage medium provided in the present application stores computer-readable program instructions (i.e., a computer program) for executing the aforementioned gesture interaction control method. This computer-readable storage medium can address the low accuracy of gesture interaction control in existing technologies. Compared to related arts, the beneficial effects of the computer-readable storage medium provided in the present application are similar to those of the gesture interaction control method provided in the aforementioned embodiments, and are not further elaborated here.

The above description is only part of the embodiments of the present application and does not limit the patent scope of the present application. All equivalent structural transformations made by using the contents of the present application specification and drawings under the technical concept of the present application, or direct/indirect application in other related technical fields are included in the patent protection scope of the present application.

What is claimed is:

1. A gesture interaction control method, comprising:
obtaining pixel position information of multiple key points of an object to be identified;
determining a gesture type according to the pixel position information;
performing coordinate conversion on the pixel position information to obtain position information of a display device; and
based on a virtual input device, controlling a behavior of the object to be identified on an interactive interface according to the gesture type and the position information of the display device.

2. The gesture interaction control method according to claim 1, wherein the determining the gesture type according to the pixel position information comprises:
dividing the pixel position information to obtain pixel position information of multiple key points of each finger;
calculating a first Euclidean distance and a second Euclidean distance of each finger based on the pixel position information of the multiple key points of each finger based on a preset distance algorithm; and
in response to that a condition of tucking five fingers together is not satisfied according to the first Euclidean distance and the second Euclidean distance, determining the gesture type.

3. The gesture interaction control method according to claim 2, wherein the in response to that the condition of tucking five fingers together is not satisfied according to the first Euclidean distance and the second Euclidean distance, determining the gesture type comprises:
in response to that the condition of tucking five fingers together is not satisfied according to the first Euclidean distance and the second Euclidean distance, determining whether a first Euclidean distance of a thumb is greater than a second Euclidean distance of the thumb;
in response to that the first Euclidean distance of the thumb is greater than the second Euclidean distance of the thumb, determining whether a first Euclidean distance of an index finger is less than or equal to a second Euclidean distance of the index finger, whether a first Euclidean distance of a middle finger is less than or equal to a second Euclidean distance of the middle finger, whether a first Euclidean distance of a ring finger is less than or equal to a second Euclidean distance of the ring finger, and whether a first Euclidean distance of a little finger is less than or equal to a second Euclidean distance of the little finger;
in response to that the first Euclidean distance of the index finger is less than or equal to the second Euclidean distance of the index finger, the first Euclidean distance of the middle finger is less than or equal to the second Euclidean distance of the middle finger, the first Euclidean distance of the ring finger is less than or equal to the second Euclidean distance of the ring finger, and the first Euclidean distance of the little finger is less than or equal to the second Euclidean distance of the little finger, determining relative positions of a thumb tip and a little finger tip according to characteristic values of a tucking degree of the index finger, middle finger, ring finger and little finger and a type of the object to be identified;
determining orientations of the index finger, middle finger, ring finger, and little finger according to the relative positions; and
in response to that the orientation is a preset orientation, determining the gesture type is return.

4. The gesture interaction control method according to claim 2, wherein the in response to that the condition of tucking five fingers together is not satisfied according to the first Euclidean distance and the second Euclidean distance, determining the gesture type comprises:
in response to that the condition of tucking five fingers together is not satisfied according to the first Euclidean distance and the second Euclidean distance, determining whether a first Euclidean distance of an index finger is greater than a second Euclidean distance of the index finger;
in response to that the first Euclidean distance of the index finger is greater than the second Euclidean distance of the index finger, determining whether a first Euclidean distance of a middle finger is less than or equal to a second Euclidean distance of the middle finger, whether a first Euclidean distance of a ring finger is less than or equal to a second Euclidean distance of the ring finger, and whether a first Euclidean distance of a little finger is less than or equal to a second Euclidean distance of the little finger;
in response to that the first Euclidean distance of the middle finger is less than or equal to the second Euclidean distance of the middle finger, the first Euclidean distance of the ring finger is less than or equal to the second Euclidean distance of the ring finger, and the first Euclidean distance of the little finger is less than or equal to the second Euclidean distance of the little finger, calculating an angle between a first connecting line segment and a second connecting line segment of the index finger;
adjusting an initial angle threshold according to a joint jitter error and a detection error to obtain a target angle threshold;
in response to that the angle is less than the target angle threshold, calculating a Euclidean distance between a fingertip key point of the thumb and a fingertip key point of the index finger based on the preset distance algorithm; and
in response to that the Euclidean distance between the fingertip key point of the thumb and the fingertip key point of the index finger is greater than a preset distance, determining the gesture type is cursor movement.

5. The gesture interaction control method according to claim 4, wherein after the adjusting the initial angle threshold according to the joint jitter error and the detection error to obtain the target angle threshold, the method further comprises:
in response to that the angle is greater than or equal to the target angle threshold, determining whether the Euclidean distance between the fingertip key point of the thumb and the fingertip key point of the index finger is less than or equal to the preset distance; and
in response to that the Euclidean distance between the fingertip key point of the thumb and the fingertip key point of the index finger is less than or equal to the preset distance, determining the gesture type is click or long press.

6. The gesture interaction control method according to claim 2, wherein the in response to that the condition of tucking five fingers together is not satisfied according to the first Euclidean distance and the second Euclidean distance, determining the gesture type comprises:
in response to determining that the condition of tucking five fingers together is not satisfied according to the first Euclidean distance and the second Euclidean distance, determining whether a first Euclidean distance of a middle finger is greater than a second Euclidean distance of the middle finger;
in response to that the first Euclidean distance of the middle finger is greater than the second Euclidean distance of the middle finger, determining whether a first Euclidean distance of a thumb is less than or equal to a second Euclidean distance of the thumb, whether a first Euclidean distance of a ring finger is less than or equal to a second Euclidean distance of the ring finger, and whether a first Euclidean distance of a little finger is less than or equal to a second Euclidean distance of the little finger;
in response to that the first Euclidean distance of the thumb is less than or equal to the second Euclidean distance of the thumb, the first Euclidean distance of the ring finger is less than or equal to the second Euclidean distance of the ring finger, and the first Euclidean distance of the little finger is less than or equal to the second Euclidean distance of the little finger, determining whether an angle between a first connecting line segment and a second connecting line segment of the index finger is greater than or equal to a target angle threshold, and whether an angle between the first connecting line segment and the second connecting line segment of the middle finger is greater than or equal to the target angle threshold; and
in response to that the angle between the first connecting line segment and the second connecting line segment of the index finger is greater than or equal to the target angle threshold, and the angle between the first connecting line segment and the second connecting line segment of the middle finger is greater than or equal to the target angle threshold, determining the gesture type is custom.

7. The gesture interaction control method according to claim 1, wherein the based on the virtual input device, controlling the behavior of the object to be identified on the interactive interface according to the gesture type and the position information of the display device comprises:
creating the virtual input device through a target mechanism;
de-jittering the position information of the display device based on a gesture interaction management module;
sending the de-jittered position information of the display device to the virtual input device; and
based on the virtual input device, controlling the behavior of the object to be identified on the interactive interface according to the gesture type and the de-jittered position information of the display device.

8. A gesture interaction control apparatus, comprising:
an acquisition module, configured to obtain pixel position information of multiple key points of an object to be identified;
a determination module, configured to determine a gesture type according to the pixel position information;
a conversion module, configured to perform coordinate conversion on the pixel position information to obtain position information of a display device; and
a control module, configured to control, based on a virtual input device, a behavior of the object to be identified on an interactive interface according to the gesture type and the position information of the display device.

9. A gesture interaction control device, comprising:
a memory;
a processor, and
a computer program stored in the memory and executable on the processor,
wherein the computer program is configured to implement of the gesture interaction control method according to claim 1.

10. A non-transitory computer-readable storage medium, storing a computer program, wherein when the computer program is executed by a processor, the gesture interaction control method according to claim 1 is implemented.
